(19) United States
(12) Patent Application Publication
(10) Pub. No.: US 2016/0340929 A1
(43) Pub. Date: Nov. 24, 2016

(54) APPARATUS FOR OPERATING A SLIDING DOOR AND DOOR INCLUDING SAME

(71) Applicant: Eric Gagnon, Montreal (CA)

(72) Inventor: Eric Gagnon, Montreal (CA)

(21) Appl. No.: 15/159,245

(22) Filed: May 19, 2016

(30) Foreign Application Priority Data
May 23, 2015 (GB) 1509121.8

(51) Int. Cl. E05B 1/00; E05D 15/06; E05F 11/54; E05B 53/00; E06B 9/52

(52) U.S. Cl. CPC E05B 1/0015; E05B 53/001; E06B 9/52; E05F 11/54; E05D 15/06

(57) ABSTRACT

An apparatus for opening and closing of a sliding door with a foot along a sliding axis, including: a base securable to the sliding door, the base defining base first and second ends and a base longitudinal axis extending therebetween, the base longitudinal axis being substantially parallel to the sliding axis when the apparatus is operatively secured to the sliding door, the base defining opposed base first and second surfaces each extending between the base first and second ends, the base second surface facing the sliding door when the apparatus is operatively secured to the sliding door; a first protuberance extending from the base first surface; and a second protuberance extending from the base first surface, the first and second protuberances being spaced apart from each other along the base longitudinal axis.

### FIELD OF THE INVENTION

The present invention relates generally to doors and, more particularly, to an apparatus for operating a sliding door and to a door including the apparatus.

### BACKGROUND

Hands-free handles for opening and closing a sliding door such as, for example, a patio door in residential homes and apartment buildings, are known. Such known hands-free handles typically include a base portion attachable to an interior and/or exterior surface portion of the sliding door, with the base portion defining a protruding portion extending substantially perpendicularly away from the surface of the sliding door. Depending of the height at which the hands-free handle is attached to the sliding door relative to the door sill, a user holding a serving tray with both hands may advantageously use the toe end of a foot, a heel, a knee or an elbow to push laterally on one side or the other of the protruding portion of the hands-free handle for opening and closing the sliding door.

While these known hands-free handles can generally fulfill the main objective of allowing a user to open and close a sliding door without the use of a hand, they also entail one or more of the following disadvantages.

First, a common context in which it is useful to have a hands-free handle attached on a sliding door is when there is warm weather outside and families and friends have a meal on a table on the home patio. In this context, people go numerous times in and out through the patio door with a serving tray held with both hands, either to serve beverages and meals or to clear items from the patio table. Often, the patio door is then the light and easily slidable screen patio door, rather than the relatively more heavy glass patio door of the patio door structure, that is swung open and closed at each passage in order to keep the summer bugs out of the house as much as possible.

Typical screen patio doors are represented by four light frame members forming a square within which is stretched a screen fabric. Furthermore, each of the four frame members are relatively narrow in cross-section, which only offers limited surface portions for attaching the hands-free handle. Alternatively, attaching a hands-free handle to the surface of a screen fabric would necessarily require strong silicone glue, screws, or the likes, which would inevitably result in an undesired damage of the screen fabric and an unstable hands-free handle due to the flexible nature of the screen fabric.

Hence, these known hands-free handles are substantially limited for attachment along the relatively narrow side surface of the bottom frame member of the screen patio door. Alternatively, attaching one of these known hands-free handles at a height along the leading vertical frame member of the screen patio door wouldn't allow a user sufficient space to open the door with a knee or an elbow since the hands-free handle would end up positioned immediately adjacent the structural frame opening of the patio door construction when in a closed position.

Furthermore, when a hands-free handles is attached along the bottom frame member of the screen patio door, it requires from the user some body balance on one foot and simultaneously some precision with the other foot in order to reach and position the latter along the side of the protruding portion of the hands-free handle. Also, the rather large door sill on the interior side of the patio door construction further complicates this operation since the hands-free handle is located deep in the corner formed at the junction between the screen patio door and the door sill. The same problem is further acerbated if the user attempts to slide the screen patio door with the heel.

Furthermore, the single protruding portion of these known hands-free handles requires some more body balance and precision from the user since it is common to have, for example, a change of mind to go back to the kitchen for a forgotten item just as we are sliding open the patio door. At such moment, while still standing on one foot and holding a serving tray with both hand, a user needs to reposition the extended leg and foot on the other side of the protruding portion in order to close the screen patio door.

In view of the above, there is a need in the industry for an improved apparatus for operating a sliding door and for a door including same.

An object of the present invention is to provide such an apparatus and such a door.

### SUMMARY OF THE INVENTION

In a broad aspect, the present invention provides an apparatus for opening and closing a sliding door with a foot, the sliding door being slidable along a sliding axis, the apparatus including: a base securable to the sliding door, the base defining base first and second ends and a base longitudinal axis extending therebetween, the base longitudinal axis being substantially parallel to the sliding axis when the apparatus is operatively secured to the sliding door, the base defining opposed base first and second surfaces each extending between the base first and second ends, the base second surface facing the sliding door when the apparatus is operatively secured to the sliding door; a first protuberance extending from the base first surface; and a second protuberance extending from the base first surface, the first and second protuberances being spaced apart from each other along the base longitudinal axis.

The first and second protuberances are portions of the apparatus that are raised with respect to adjacent portions of the apparatus and that can be engaged by the foot to slide the sliding door.

The invention may also provide an apparatus wherein the base is substantially plate-shaped.

The invention may also provide an apparatus wherein the first and second protuberances are substantially elongated in a direction parallel to the base first surface.

The invention may also provide an apparatus wherein the first and second protuberances are substantially perpendicular to the base longitudinal axis.

The invention may also provide an apparatus wherein the first and second protuberances are substantially parallel to each other.

The invention may also provide an apparatus wherein the first and second protuberances are respectively substantially adjacent the base first and second ends.

The invention may also provide an apparatus wherein the base is substantially rectangular.

The invention may also provide an apparatus wherein the first protuberance is substantially adjacent the base first end and the second protuberance is substantially spaced apart from the base second end, the base defining a base protruding portion between the second protuberance and the base second end.

The invention may also provide an apparatus wherein the base protruding portion defines a base protruding portion peripheral edge, the base protruding portion peripheral edge including an arc segment shaped portion.

The invention may also provide an apparatus wherein the sliding door includes a mosquito screen supported by a frame, at least part of the arc segment shaped portion being in register with the mosquito screen when the base is operatively secured to the sliding door.

The invention may also provide an apparatus wherein the base protruding portion is substantially trapezoid shaped.

The invention may also provide an apparatus further comprising a mounting system for removably mounting the base to the sliding door.

The invention may also provide an apparatus wherein the mounting system includes pairs of complimentary patches of miniature hook and loop material, each pair including a first patch secured to the sliding door and a second patch secured to the base, the first and second patches being in register with each other and secured to each other when the apparatus is operatively secured to the sliding door.

The invention may also provide an apparatus wherein the first and second protuberances and the base are integrally formed as a single piece of material.

The invention may also provide an apparatus wherein the base is a first base and the base second surface is a first base second surface, the apparatus further including a second base securable to the sliding door, the second base defining opposed second base first and second surfaces, the second base second surface facing the sliding door when the apparatus is operatively secured to the sliding door, the first and second base second surfaces facing each other with the sliding door therebetween when the apparatus is operatively secured to the sliding door; a third protuberance extending from the second base first surface; and a fourth protuberance extending from the second base first surface.

The invention may also provide an apparatus wherein the first and second bases are mirror image of each other.

In another broad aspect, the invention provides a sliding door including: a door element, the door element defining a door element bottom end and opposed door element first and second sides, the sliding door being slidable along a sliding axis extending between the door element first and second sides; and a door closing and opening apparatus secured to the door element and provided substantially adjacent a junction between the door element bottom end and the door element first side, the door closing and opening apparatus including a base secured to the door element, the base defining base first and second ends and a base longitudinal axis extending therebetween, the base longitudinal axis being substantially parallel to the sliding axis; a first protuberance extending from the base away from the door element; and a second protuberance extending from the base away from the door element, the first and second protuberances being spaced apart from each other along the base longitudinal axis.

The door element is a conventional door, such as, for example, a mosquito screen door or a door including a glass pane. The door closing and opening apparatus is secured to the door element either being removable therefrom or being permanently secured thereto, either by being permanently attached thereto or by being integrally formed therewith. Removing the apparatus can be advantageous in climates in which there is snow to facilitate snow removal during the cold season and to reduce the likelihood that the door will be blocked with the apparatus stuck in snow or ice. Also, one could remove the apparatus while away from home to reduce the chances that the apparatus is stolen.

The invention may also provide a sliding door wherein the base is substantially plate-shaped.

The invention may also provide a sliding door wherein the first and second protuberances are substantially elongated in a direction parallel to the base first surface.

The invention may also provide a sliding door wherein the first and second protuberances are substantially perpendicular to the base longitudinal axis.

The invention may also provide a sliding door wherein the first and second protuberances are respectively substantially adjacent the base first and second ends.

The invention may also provide a sliding door wherein the base is substantially rectangular.

The invention may also provide a sliding door wherein the door element includes a frame supporting a mosquito screen therein; the first protuberance is substantially adjacent the base first end and the second protuberance is substantially spaced apart from the base second end; the base defines a base protruding portion between the second protuberance and the base second end; at least part of the base is secured to the frame; and at least part of the base protruding portion is in register with the mosquito screen.

The invention may also provide a sliding door wherein the base protruding portion defines a base protruding portion peripheral edge, the base protruding portion peripheral edge including an arc segment shaped portion provided at least in part in register with the mosquito screen.

The invention may also provide a sliding door wherein the base protruding portion defines a base protruding portion peripheral edge, the base protruding portion peripheral edge being devoid of angles sharper than 60 degrees in register with the mosquito screen.

The invention may also provide a sliding door wherein the base protruding portion is substantially trapezoid shaped.

The invention may also provide a sliding door wherein the base is removably secured to the door element.

The invention may also provide a sliding door wherein the base is a first base and the base second surface is a first base second surface, the door opening and closing apparatus further including a second base mounted to the sliding door in register with the first base with the door element therebetween, the second base defining opposed second base first and second surfaces, the second base second surface facing the sliding door, the first and second base second surfaces facing each other with the sliding door therebetween; a third protuberance extending from the second base away from the sliding door; and a fourth protuberance extending from the second base away from the sliding door.

The proposed apparatus allows a user to open and close a sliding door with either a toe end of a foot, a heel, a knee or an elbow, depending of the user selected vertical position of the hands-free handle on the sliding door.

Furthermore, in some embodiments, the available extended vertical dimension of the handle component that extends at least partially parallelly relative to the mosquito screen, as opposed to known hands-free handles of the prior art, requires significantly less body balance and precision to reach and use, particularly when standing on one foot while reaching the hands-free handle with the toe end or heel portion of the other foot.

Furthermore, the pair of protuberances allows a user to keep, for example, the toe end of a foot engaged with the hands-free handle even though a change mind of the user occurs while opening or closing the sliding door.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in an exploded, perspective environmental view, illustrates an embodiment of an apparatus for opening and closing a sliding door, according to the present invention, here shown removably attached on opposed side surfaces of a lower frame corner of a sliding patio door provided with a mosquito screen;

FIG. 2, in a front elevational view, illustrates a first element part of the apparatus of FIG. 1, here shown attached to a lower frame corner of the sliding patio door;

FIG. 3, in a rear elevational view, illustrates the first element of FIG. 2;

FIG. 4, in a side elevational view, illustrates the first element of FIG. 2, here shown detached from the door frame side surface of the sliding door;

FIG. 5, in a top plan view, illustrates the first element shown in FIG. 4;

FIG. 6, in an environmental side elevational view, illustrates the apparatus of FIG. 1 attached on opposed sides surfaces of a lower frame corner of the sliding patio door, wherein the first element is shown engaged by the toe end of a foot of a user for laterally sliding the sliding door;

FIG. 7, in an environmental side elevational view, illustrates the apparatus of FIG. 1, wherein the first element is shown engaged by the heel portion of a foot of a user for laterally sliding the sliding door;

FIG. 8, in an exploded perspective view, illustrates the apparatus of FIG. 1 attached on opposed side surfaces of a lower frame corner of a sliding patio door using screws;

FIG. 9, in a top plan view, illustrates an alternate embodiment of the apparatus of the present invention, here showing a pair of elements thereof attached on opposed side surfaces of a sliding patio door, and with a toe end of a foot pressing centrally on one of the two hands-free handle towards the other;

FIG. 10, in an exploded perspective view, illustrates the apparatus of FIG. 9; here shown attached on opposed side surfaces of a lower frame corner of a sliding patio door, wherein one of the elements is shown engaged by the toe end of a foot of a user for laterally sliding the sliding patio door;

FIG. 11, in an exploded perspective view, illustrates the apparatus of FIG. 9; here shown attached on opposed side surfaces along a leading edge portion of a sliding door, between the bottom end of the sliding door and a conventional handle thereof, and wherein one of the hands-free handle is shown engaged by a knee of a user for laterally sliding the sliding door;

FIG. 12, in an exploded perspective view, illustrates the apparatus of FIG. 9; here shown attached on opposed side surfaces along a leading edge portion of a sliding patio door, and slightly above the conventional handle thereof, and wherein one of the elements is shown engaged by an elbow portion of a user for laterally sliding the sliding door;

FIG. 13, in an exploded perspective view, illustrates another alternate embodiment of an apparatus, according to the present invention, wherein the apparatus is configured for attachment to adjacent longitudinal corner surfaces of a door frame leading side member of a sliding patio door;

FIG. 14, in a top plan view, illustrates the apparatus of FIG. 13, here shown attached on oppositely corresponding adjacent longitudinal corner surfaces of a door frame leading side member of a sliding patio door;

FIG. 15, in an exploded perspective view, illustrates another alternate embodiment of an apparatus, according to the present invention, here shown provided with half-cylindrical protuberances;

FIG. 16, in an exploded perspective view, illustrates yet another alternate embodiment an apparatus according to the present invention that is formed out of a suitably shaped and bent metal sheet;

FIG. 17, in a perspective view, illustrates yet another alternate embodiment an apparatus according to the present;

FIG. 18, in an alternative perspective view, illustrates an apparatus element part of the apparatus of FIG. 17; and

FIG. 19, in a perspective view, illustrates an apparatus element part of yet another alternate embodiment an apparatus according to the present.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art. Also, directional terminology such as “bottom” is used with reference to a typical use of the invention, attached to a substantially vertical sliding door that slides substantially horizontally. However, this terminology should not be used to limit the scope of the invention unless such terminology is used in a claim.

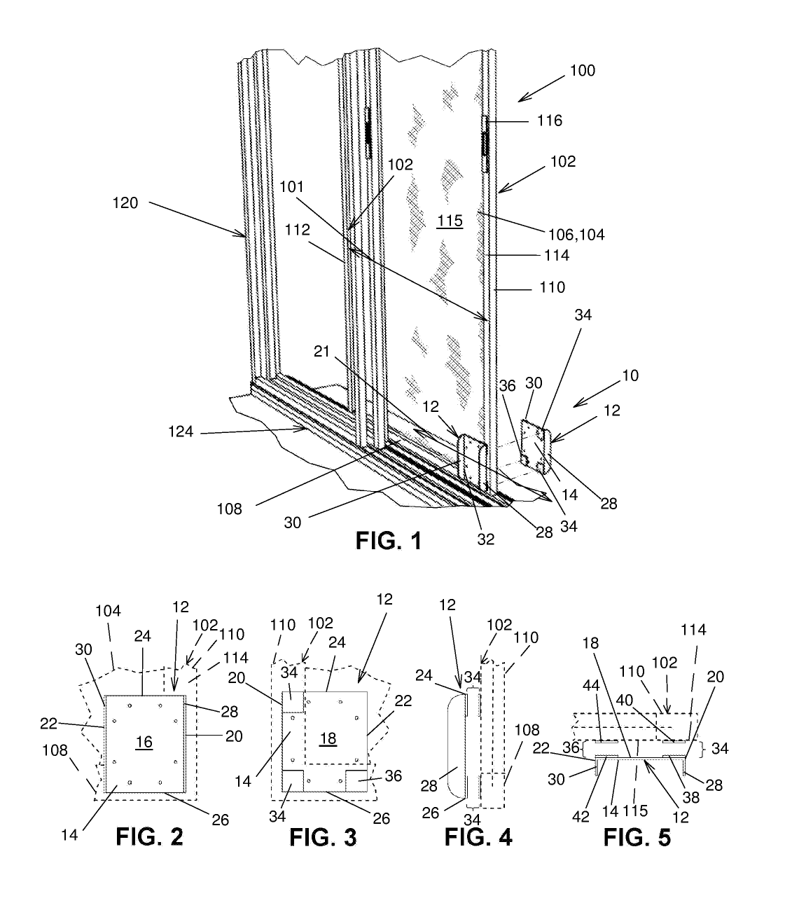

FIG. 1 illustrates various aspects of an embodiment, according to the present invention, of an apparatus 10 attachable at a user selected position on a sliding door 100 for allowing an intended user to open and close the latter using a portion of a limb other than a hand such as, for example, a toe end of a foot, a heel, a knee or an elbow.

Typically, as best illustrated in FIG. 1, the sliding door 100 has a door frame 102 and a relatively thin door inner pane 104, such as a mosquito screen 106 or a glass pane, extending substantially co-planarly centrally within the door frame 102.

The door frame 102 includes a door frame top member (not shown in the drawings), a door frame bottom member 108, and parallel door frame leading and trailing side members 110 and 112 respectively. Furthermore, the door frame 102 defines opposite door frame side surfaces 114. A pair of sliding door handles 116 is provided at a suitable height along opposed sides of the door frame leading side member 110. The sliding door 100 is slidable along a sliding axis 101, which is typically substantially horizontal.

The apparatus 10 is generally represented by an assembly comprising an apparatus element 12, a first support component 34 and a second support component 36. The first and second support components 34 and 36 form a mounting system for removably mounting the base 14 to the sliding door 100. Typically, the apparatus 10 includes two apparatus elements 12 similar to each other and attachable so as to respectively face towards the interior of a building and towards the exterior of the building. However, use of a only one apparatus element 12 is within the scope of the present invention. Also, in some embodiments, the apparatus 10 may be such that the apparatus element 12 is permanently fixed to the sliding door 100, for example welded thereto, glued thereto, or integrally formed therewith.

Referring more particularly to FIGS. 2 to 5 inclusively, the apparatus element 12 includes a base 14. The base 14 is for example substantially plate-shaped for convenient mounting to the sliding door 100, although other shapes are within the scope of the present invention, and defines opposed base first and second surfaces 16 and 18, opposed base first and second ends 20 and 22, and opposed base top and bottom edges 24 and 26 extending substantially laterally between the base first and second ends 20 and 22. For example, the base 14 is substantially rectangular, a term here including a square shape. The base 14 defines a base longitudinal axis 21 (seen in FIG. 1) extending between the base first and second ends 20 and 22. It should be noted that the term longitudinal here does not imply that the length of the base top and bottom edges 24 and 26 is larger than the distance therebetween. It is only used conveniently to denote an orientation between the base first and second ends. When the apparatus 10 is mounted to the sliding door 120, the base second surface 18 faces towards, and extends substantially parallelly adjacently relative to, one of the door frame side surfaces 114. Also, the base longitudinal axis 21 is substantially parallel to the sliding axis 101.

The distance between the base top and bottom edges 24 and 26 is typically at least slightly greater than a cross-section dimension of the door frame bottom member 108. The base top and bottom edges 24 and 26 each have a length dimension that is at least slightly greater than a cross-section dimension of the door frame leading side member 110. Thus, with a first corner of the base 14 positioned in register with the junction of the door frame bottom member 108 and the door frame leading side member 110, at least a portion of the diametrically opposite corner of the base 14 extends in a parallelly spaced apart relationship relative to the door inner pane 104.

The apparatus element 12 further includes a first and a second protuberance 28 and 30 extending outwardly from the base first surface 16, the first and second protuberances being spaced apart from each other along the base longitudinal axis 21. In the apparatus 10, the first and second protuberances 28 and 30 are fixed relative to each other. However, it is within the scope of the invention to have such protuberances for which the distance therebetween could be varied, for example by having the base 14 in two sections slidable relative to each other, each of the sections including one of the first and second protuberances 28 and 30. It is also within the scope of the invention to have such protuberances for which the distance therebetween could be varied with the protuberances biased towards a maximal distance therebetween with a biasing element, such as a spring. Then, the sliding door could be open to a greater extent than in the case in which the protuberances are fixed relative to each other as the sliding door can keep on being pushed open when the protuberance further from the leading edge reaches the structure behind which the sliding door is retracted by allowing the distance between the two protuberances to be reduced. Correspondingly, once the door is closed, the two protuberances are back to a spaced apart relationship therebetween due to the action of the biasing element that spreads them apart. The first and second protuberances 28 and 30 are in some embodiments substantially elongated in a direction parallel to the base first surface 16, for example substantially perpendicular to the base longitudinal axis 21. In such embodiments, the first and second protuberances 28 and 30 are substantially parallel to each other. However, any other suitable configurations of the first and second protuberances is within the scope of the invention.

In the apparatus element 12, the first and second protuberances 28 and 30 are respectively substantially adjacent the base first and second ends 20 and 22. However, other locations for the first and second protuberances 28 and 30 are within the scope of the invention. An example of such an alternative configuration is described in greater details hereinbelow. In some embodiments, the first and second protuberances 28 and 30 extend along a major portion, or the entire length of the space between the base top and bottom edges 24 and 26.

The base first surface 16 adjacent surface portions of both first and second protuberances 28 and 30 cooperatively form an engaging portion 32 for engaging therewith a limb portion of a user such as a toe end of a foot, a heel, a knee, an elbow, or even a side edge portion of a shoulder.

Referring to FIG. 5, the first support component 34 defines an inner surface portion 38 attached along the base second surface 18 and substantially adjacent the base first end 20, and an outer surface portion 40 attached at a user selected vertical position along the door frame side surface 114, on the door frame leading side member 110.

The second support component 36 defines an inner surface portion 42 attached along the base second surface 18 and substantially adjacent the base second end 22. The second support component 36 further defines an outer surface portion 44 exclusively contacting the door frame side surface 114 on the door frame bottom member 108, as exemplified in FIG. 4, or exclusively a side surface portion 115 of the door inner pane 104, as exemplified in FIGS. 11 and 12, or both on the door frame bottom member 108, and on the side surface portion 115 of the door inner pane 104, as exemplified in FIG. 10.

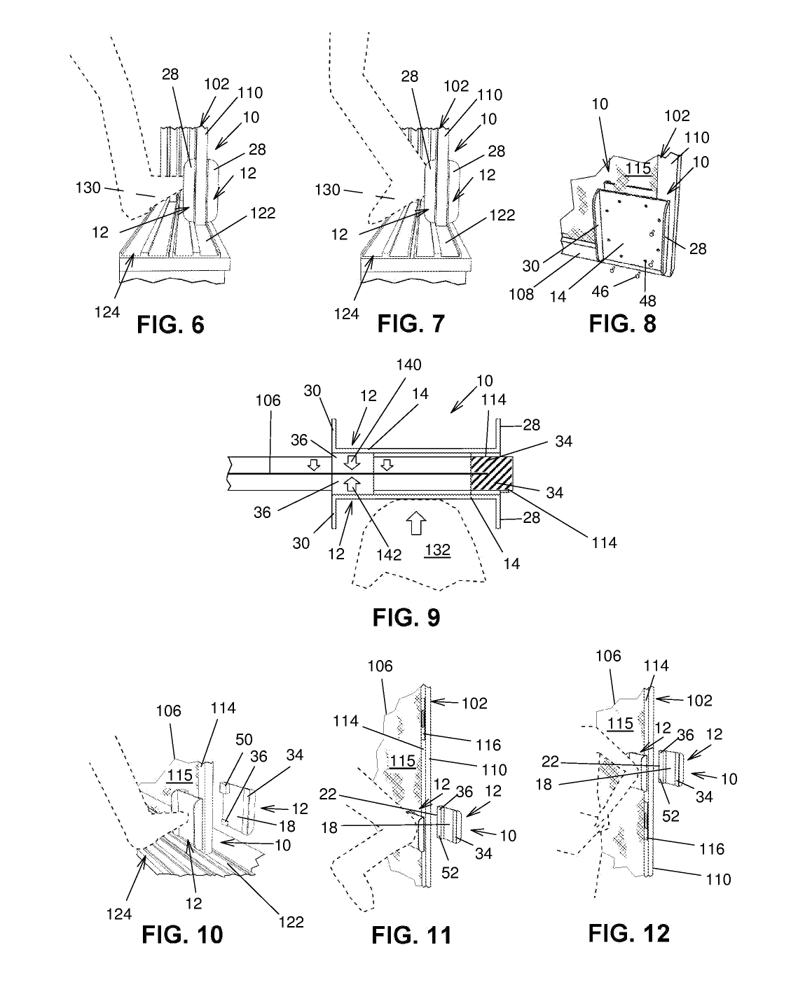

Thus with the outer surface portion 40 of the first support component 34 attached at a user selected vertical position along the door frame leading side member 110, the user may engage a suitable limb portion 130 (seen in FIGS. 6 and 7) along the engaging portion 32 and urge a lateral force towards the base first or second ends 20 or 22, for respectively closing or opening the sliding door 100 without necessarily the use of a hand.

In some embodiments, the dimensions of the apparatus element 12 may be as follows, although other dimensions are within the scope of the present invention. The base first and second ends 20 and 22 may have a length dimension between five (5) and twenty (20) centimeters (between about two and eight inches). The base top and bottom edges 24 and 26 may have a length dimension between five (5) and ten (10) centimeters (between about two and four inches). The first and second protuberances 28 and 30 may extend outwardly for the base first surface 16 a distance of between one (1) centimeter and at least a slightly greater distance than the distance separating the two door frames 102 in a typical sliding patio door assembly 120.

In a very specific embodiment of the invention, the base first and second ends 20 and 22 have a length dimension of about 10 centimeters (about four inches), the base top and bottom edges 24 and 26 have a length dimension of about 7.5 centimeters (about three inches), and the first and second protuberances 28 and 30 extend a distance of about two (2) centimeters, which is at least slightly greater than the distance separating the two door frames 102 in a typical sliding patio door assembly 120. Thus dimensioned, the second protuberance 30 prevents the apparatus 10 from being tossed in an unreachable position between the two adjacent door frames 102 in a typical sliding patio door assembly 120.

The apparatus element 12 is made of a suitably rigid material such as, for example, a suitable metal, a polymeric material, wood, or a combination thereof. The apparatus element 12 could also be manufactured using Computer Numerical Control (CNC) devices.

For example, in some embodiments, the apparatus element 12 may be advantageously made out of a single sheet of metal suitably bent in a form substantially representing the base 14 and both protuberances 28 and 30 respectively using conventional manufacturing processes and methods, such the first and second protuberances 28 and 30 and the base 14 are integrally formed as a single piece of material.

In some other embodiments, the apparatus element 12 may be represented by a single piece of plastic using a conventional injection molding process, such the first and second protuberances 28 and 30 and the base 14 are integrally formed as a single piece of material.

In yet some other embodiments, the apparatus element 12 may be represented by an assembly of individual sub-components represented by a base sub-component and two individual protuberance sub-components (not shown in the drawings) that are, for example, thermo-bonded, glued or mutually engaged in a snap-fit relation to one another.

As would be obvious to someone familiar with conventional sliding patio doors, the apparatus 10 must be attached along the door frame side surface 114 at a sufficient distance from the peripheral edge thereof to avoid contacting the sliding door engaging tracks 122 along the door sill 124 and vertical door jamb of the sliding patio door assembly 120 (as best illustrated in FIG. 1).

In some embodiments, as illustrated in FIGS. 1 to 5 inclusively, the first support component 34 is represented by one or more self-adhesive pair of mating miniature hoop and loop material patches (Velcro®) in a spaced apart relationship along the base first end 20. The mating patches are in register with each other and secured to each other when the apparatus 10 is operatively secured to the sliding door 100. Thus, a user may selectively remove and reattach the apparatus element 12 from the sliding door 100 for periodic cleaning purposes thereof, for example.

In some other embodiments of the present invention, as illustrated in FIGS. 10 to 12, 15 and 16, the first support component 34 may be represented by a single self-adhesive pair of mating Velcro® elements extending substantially the whole length of the base first end 20.

In another embodiment, as illustrated in FIG. 8, the first support component 34 may be represented by one or more screws 46 engaged through corresponding apertures 48 and into the side surface of the door frame leading side member 110.

Alternatively, as would be obvious to someone familiar with door handles, the first support component 34 may be represented by double sided adhesive tape or suitable glue (not shown in the drawings).

In some embodiments, with the apparatus element 12 positioned to at least partially overlap the door frame bottom member 108, as illustrated in FIGS. 1 to 5 inclusively, the second support component 36 is represented by a same type of attachment element selected for the first support component 34 described above. For example, as illustrated in the figures, at least one self-adhesive pair of mating Velcro® elements may be mounted between a lower end portion of the base second end 22 and the door frame bottom member 108.

Thus, the apparatus element 12 is sufficiently rigidly supported relative to the door frame 102, and away from the mosquito screen 106 extending there within, through a lower corner portion of the door frame 102.

In some embodiments, as illustrated in FIG. 10, the second support component 36 further includes a suitably sized and shaped spacer element 50 attached along the base second surface 18 and substantially adjacent to a top end portion of the base second end 22, for additional support of the apparatus element 12 on the mosquito screen 106 or alternatively on a glass pane of the sliding door 100. The spacer element 50 is for example made of a resilient material such as a sufficiently rigid foam material, a rubber material, or equivalent.

With the apparatus element 12 positioned away from the door frame bottom member 108, as illustrated in FIGS. 11 and 12, in another embodiment of the second support component 36, the latter is represented by a suitably sized and shaped spacer element 52 extending substantially the whole vertical dimension of the base second surface 18 and substantially adjacently the base second end 22.

The apparatus element 12 thus rigidly supported at least partially along the door frame leading side member 110, and partially on the door inner pane 104, a relatively limited pressure is evenly distributed along the mosquito screen 106 through the substantially elongated spacer element 52 when a user presses with a limb portion on the apparatus element 12.

Hence, the present embodiment of a apparatus 10 applies little or no damaging pressure transversally against the mosquito screen 106 and, yet, provides a user with a relatively large apparatus element 12 that requires significantly less body balance and precision to operate the sliding door 100, when compared to known prior art hands-free handles.

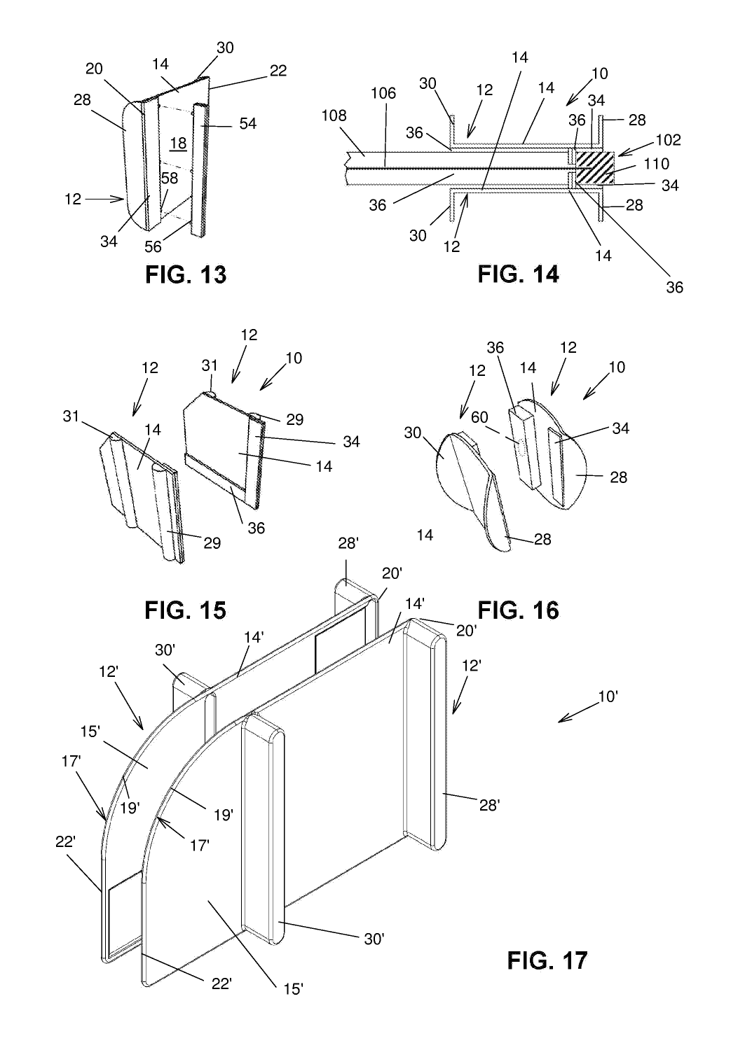

With the apparatus element 12 again positioned away from the door frame bottom member 108, in yet another embodiment of the second support component 36, as illustrated in FIGS. 13 and 14, the latter includes a suitably sized and shaped ledge member 54. The ledge member 54 is for example attached to, and extends substantially the whole vertical dimension of, the base second surface 18 in a parallelly spaced apart relationship relative to the base first end 20. Furthermore, the ledge member 54 extends distally outwardly from the base second surface 18 a distance that is substantially equivalent to the typical distance, or depth, between the door frame side surface 114 and the mosquito screen 106. Likewise the previously described embodiment of a second support component 36, the latter further typically includes a same type of attachment element as the one used for the first support component 34.

Thus, the apparatus element 12 may be supported substantially parallelly relative to the door frame side surface 114 through an inner corner surface portion of the door frame leading side member 110 in a cantilever fashion without relying on a partial support on the patio door inner pane 104.

The assembly representing the second support component 36 may be an individual component that can be user selectively attached to the base second surface 18 through compatibly shaped mating pins 56 and locking bores 58 combinations for rigidly engaging the second support component 36 with the apparatus element 12 in a snap-fit relation therebetween. Alternatively, the ledge member 54 may be integrally formed with the apparatus element 12.

Referring more particularly to FIG. 9, in another alternate embodiment of the present invention that is particularly suited for a sliding door 100 having a mosquito screen 106 as a door inner pane 104, the invention includes two apparatus elements 12 like the one illustrated in FIGS. 11 and 12, which are attached on oppositely corresponding frame side surfaces 114 on the door frame leading side member 110 that are at least slightly above the door frame bottom member 108 so as to have both second support components 36 abutting on correspondingly opposite side surfaces of the mosquito screen 106.

Thus, the rigidity of the attachment between one of the base 14 and the door frame leading side member 110 through the elongated first support component 34, and the inherent rigidity of the typically stretched mosquito screen 106 of the sliding door 100, provide a significant combined force 140 that opposes the oppositely directed force 142 urged by, for example, the toe end of a user's foot 132 on the base 14 on the other side of the sliding door 100.

Hence, less pressure is repetitively applied transversally on the mosquito screen 106 which, in turn, reduces any undesired stretching of, or markings on, portions of the mosquito screen 106 pressed between the oppositely facing second support components 36.

In some instances of the presently described embodiment of the invention, each oppositely facing second support components 36 on each side of the mosquito screen 106 may include at least one element 60 magnetically attracted to a corresponding element in the oppositely facing second support component 36 (as exemplified in FIG. 16).

Thus, with each oppositely facing second support components 36 magnetically attracted to one another, these may be prevented from generating annoying flapping noises against one another due to a fluctuating wind breeze against the mosquito screen 106.

In some embodiments of the apparatus element 12, the protuberances 28 and 30 may be represented by substantially elongated plate members, as illustrated for example, in FIGS. 1 and 10 or, alternatively, by a pair of substantially elongated half-cylindrical protruding shapes, as illustrated in FIG. 15 for protuberances 29 and 31. Other equivalent shapes of the protuberances 28 and 30 are also possible.

Advantageously, the present invention may be sold as a kit comprising two apparatus elements 12 that are each readily provided with a first support component 34 attached thereto and, individually, selected embodiments of the second support component 36 as described further above that the user may choose from.

Thus the various embodiments described above provide an apparatus 10, according to the present invention, that can be attached to substantially any user desired vertical position along the door frame leading side member 110, including on a sliding door 100 having a mosquito screen 106 as a door inner pane 104.

Hence, the apparatus 10 of the present invention allows a user to open and close a sliding door 100 with either a toe end of a foot, a heel, a knee or an elbow, depending of the user selected vertical position of the hands-free handle on the sliding door 100.

Furthermore, in some embodiments, the available extended vertical dimension of the apparatus 10 that extends at least partially parallelly relative to the mosquito screen 106, as opposed to known hands-free handles of the prior art, requires significantly less body balance and precision to reach and use, particularly when standing on one foot while reaching the hands-free handle with the toe end or heel portion of the other foot.

Furthermore, the pair of protuberances 28 and 30 allows a user to keep, for example, the toe end of a foot engaged with the apparatus 10 even though a change mind of the user occurs while opening or closing the sliding door 100.

With reference to FIG. 17, there is shown another embodiment of the apparatus 10, apparatus 10′. Apparatus 10′ is similar in function to apparatus 10 and only the differences therebetween are described herein. Reference numerals with a ′ appended refer to elements of the apparatus 10′ that have a function similar to the same element numbered without a ′ in the apparatus 10.

The apparatus 10′ includes a base 14′ defining base first and second ends 20′ and 22′ from which first and second protuberances 28′ and 30′ extend. As in the apparatus 10, the first protuberance 28′ is substantially adjacent the base first end 20′, that is the end of the base 14′ that is secured to the door leading edge 110 (not shown in FIG. 17). However, the second protuberance 30′ is substantially spaced apart from the base second end 22′. Thus, the base 14′ defines a base protruding portion 15′ between the second protuberance 30′ and the base second end 20′. Advantageously, when the sliding door 100 includes a mosquito screen 106, the base protruding portion 15′ distributes over a larger surface area any pressure that may be exerted on the mosquito screen 106 when the user presses on the base 14′, either to better engage the apparatus 10′ or inadvertently. Also, this pressure is reduced due to the larger distance between the point of contact between the user and the base 14′ and the base second end 22′ compared to the apparatus 10, which reduces the moment arm of this force.

The protruding portion 15′ defines a base protruding portion peripheral edge 17′. In the apparatus 10′, the base protruding portion peripheral edge 17′ including an arc segment shaped portion 19′. As will be apparent when comparing FIGS. 17 and 1, at least part of the arc segment shaped portion 19′ in register with the mosquito screen 106 when the base 14′ is operatively secured to the sliding door 100. This shape eliminates a right angle corner that would be present in a rectangular protruding portion (not shown in the drawings). Such right angle corners have a potential through repeated motion on the mosquito screen 106 to pierce the mosquito screen 106.

More generally, in some embodiments, there is an absence of any sharp point in the base protruding portion peripheral edge 17′ at locations thereof that are in register with the mosquito screen 106 when in use can potentially present similar advantages. For example, the base protruding portion peripheral edge 17′ is devoid of angles sharper than 60 degrees in register with the mosquito screen 106. In a specific alternative embodiment, the apparatus 10″, seen in FIG. 19, the base protruding portion 15″ is trapezoid shaped, with right angles only in portions of the apparatus element 12″ that are in register with the door frame 102 (not shown in FIG. 19).

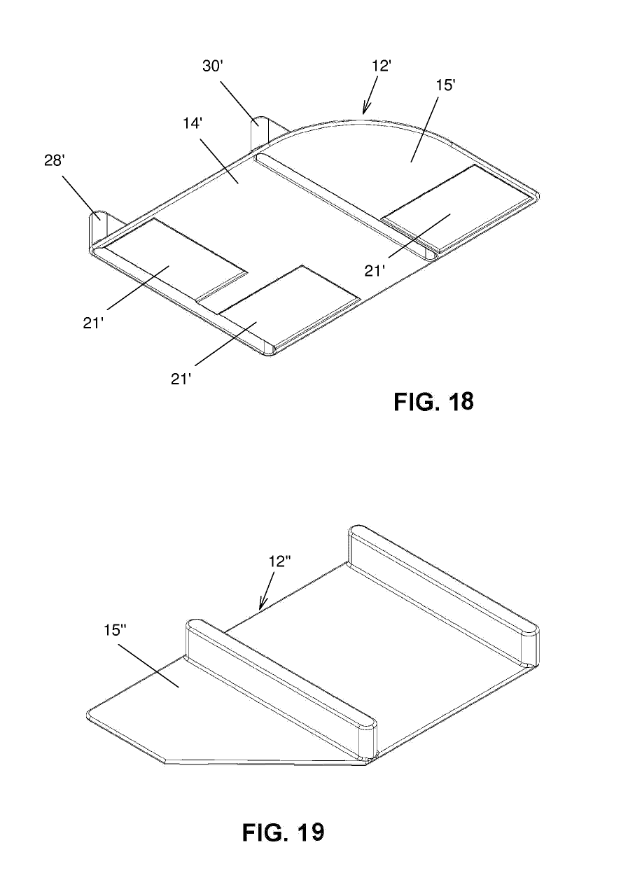

With reference to FIG. 18, in some embodiments, the base second surface 18′ of the base 14′ is provided with recesses 21′. The recesses 21′ are for receiving and securing thereinto a patch of miniature loop material or of miniature hook material that will be used to secure the base 14′ to the sliding door 100 as described hereinabove for the base 14 and apparatus 10.

In all embodiments, the first and second protrusions 28 and 30 could be removably mounted to the base 14 in manners known in the art to facilitate shipping. Also, while the base 14 is typically rigid, in alternative embodiments, the base 14 could be foldable to minimize packaging and shipping costs.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. An apparatus for opening and closing a sliding door with a foot, the sliding door being slidable along a sliding axis, the apparatus comprising:
a base securable to the sliding door, the base defining base first and second ends and a base longitudinal axis extending therebetween, the base longitudinal axis being substantially parallel to the sliding axis when the apparatus is operatively secured to the sliding door, the base defining opposed base first and second surfaces each extending between the base first and second ends, the base second surface facing the sliding door when the apparatus is operatively secured to the sliding door;
a first protuberance extending from the base first surface; and
a second protuberance extending from the base first surface, the first and second protuberances being spaced apart from each other along the base longitudinal axis.

2. The apparatus as defined in claim 1, wherein the base is substantially plate-shaped.

3. The apparatus as defined in claim 1, wherein the first and second protuberances are substantially elongated in a direction parallel to the base first surface.

4. The apparatus as defined in claim 3, wherein the first and second protuberances are substantially perpendicular to the base longitudinal axis.

5. The apparatus as defined in claim 2, wherein the first and second protuberances are substantially parallel to each other.

6. The apparatus as defined in claim 1, wherein the first and second protuberances are respectively substantially adjacent the base first and second ends.

7. The apparatus as defined in claim 1, wherein the base is substantially rectangular.

8. The apparatus as defined in claim 1, wherein the first protuberance is substantially adjacent the base first end and the second protuberance is substantially spaced apart from the base second end, the base defining a base protruding portion between the second protuberance and the base second end.

9. The apparatus as defined in claim 8, wherein the base protruding portion defines a base protruding portion peripheral edge, the base protruding portion peripheral edge including an arc segment shaped portion.

10. The apparatus as defined in claim 9, wherein the sliding door includes a mosquito screen supported by a frame, at least part of the arc segment shaped portion being in register with the mosquito screen when the base is operatively secured to the sliding door.

11. The apparatus as defined in claim 8, wherein the base protruding portion is substantially trapezoid shaped.

12. The apparatus as defined in claim 1, further comprising a mounting system for removably mounting the base to the sliding door.

13. The apparatus as defined in claim 12, wherein the mounting system includes pairs of complimentary patches of miniature hook and loop material, each pair including a first patch secured to the sliding door and a second patch secured to the base, the first and second patches being in register with each other and secured to each other when the apparatus is operatively secured to the sliding door.

14. The apparatus as defined in claim 1, wherein the first and second protuberances and the base are integrally formed as a single piece of material.

15. The apparatus as defined in claim 1, wherein the base is a first base and the base second surface is a first base second surface, the apparatus further comprising
a second base securable to the sliding door, the second base defining opposed second base first and second surfaces, the second base second surface facing the sliding door when the apparatus is operatively secured to the sliding door, the first and second base second surfaces facing each other with the sliding door therebetween when the apparatus is operatively secured to the sliding door;
a third protuberance extending from the second base first surface; and
a fourth protuberance extending from the second base first surface.

16. The apparatus as defined in claim 15, wherein the first and second bases are mirror image of each other.

17. A sliding door comprising:
a door element, the door element defining a door element bottom end and opposed door element first and second sides, the sliding door being slidable along a sliding axis extending between the door element first and second sides; and
a door closing and opening apparatus secured to the door element and provided substantially adjacent a junction between the door element bottom end and the door element first side, the door closing and opening apparatus including
a base secured to the door element, the base defining base first and second ends and a base longitudinal axis extending therebetween, the base longitudinal axis being substantially parallel to the sliding axis;
a first protuberance extending from the base away from the door element; and
a second protuberance extending from the base away from the door element, the first and second protuberances being spaced apart from each other along the base longitudinal axis.

18. The sliding door as defined in claim 17, wherein the base is substantially plate-shaped.

19. The sliding door as defined in claim 17, wherein the first and second protuberances are substantially elongated in a direction parallel to the base first surface.

20. The sliding door as defined in claim 19, wherein the first and second protuberances are substantially perpendicular to the base longitudinal axis.

21. The sliding door as defined in claim 17, wherein the first and second protuberances are respectively substantially adjacent the base first and second ends.

22. The sliding door as defined in claim 17, wherein the base is substantially rectangular.

23. The sliding door as defined in claim 17, wherein
the door element includes a frame supporting a mosquito screen therein;
the first protuberance is substantially adjacent the base first end and the second protuberance is substantially spaced apart from the base second end;
the base defines a base protruding portion between the second protuberance and the base second end;
at least part of the base is secured to the frame; and
at least part of the base protruding portion is in register with the mosquito screen.

24. The sliding door as defined in claim 23, wherein the base protruding portion defines a base protruding portion peripheral edge, the base protruding portion peripheral edge including an arc segment shaped portion provided at least in part in register with the mosquito screen.

25. The sliding door as defined in claim 23, wherein the base protruding portion defines a base protruding portion peripheral edge, the base protruding portion peripheral edge being devoid of angles sharper than 60 degrees in register with the mosquito screen.

26. The sliding door as defined in claim 23, wherein the base protruding portion is substantially trapezoid shaped.

27. The sliding door as defined in claim 17, wherein the base is removably secured to the door element.

28. The sliding door as defined in claim 17, wherein the base is a first base and the base second surface is a first base second surface, the door opening and closing apparatus further including
a second base mounted to the sliding door in register with the first base with the door element therebetween, the second base defining opposed second base first and second surfaces, the second base second surface facing the sliding door, the first and second base second surfaces facing each other with the sliding door therebetween;
a third protuberance extending from the second base away from the sliding door; and
a fourth protuberance extending from the second base away from the sliding door.
